(19) United States
(12) Patent Application Publication
(10) Pub. No.: US 2022/0101832 A1
(43) Pub. Date: Mar. 31, 2022

(54) Translating, Recording, And Playback Device

(71) Applicants: Sean Neilly, Groveland, FL (US); Chandra Neilly, Groveland, FL (US)

(72) Inventors: Sean Neilly, Groveland, FL (US); Chandra Neilly, Groveland, FL (US)

(21) Appl. No.: 17/032,179

(22) Filed: Sep. 25, 2020

(51) Int. Cl. G10L 15/183; H04R 1/02; H04R 1/04; G06F 3/02; H04R 3/00; G06F 3/16; G10L 15/22

(52) U.S. Cl. CPC G10L 15/183; H04R 1/028; H04R 1/04; G06F 3/0202; H04R 2499/11; G06F 3/165; G06F 3/167; G10L 15/22; H04R 3/00

(57) ABSTRACT

A translating, recording, and playback device for real time and delayed playback of translated speech includes a microprocessor positioned in an interior space defined by a housing. The microprocessor is operationally engaged to a data storage module, which is engaged to the housing and positioned in the interior space. The microprocessor also is operationally engaged to a microphone and a speaker, which are engaged to the housing. Translation programming code positioned on the microprocessor enables the microprocessor to translate an audio signal received from the microphone from a first language to a second language. The translation programming code also enables the microprocessor to selectively send a translated audio signal to the data storage module and the speaker.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (g) STATEMENT REGARDING PRIOR DISCLOSURES BY THE INVENTOR OR JOINT INVENTOR

Not Applicable

### (g) BACKGROUND OF THE INVENTION

### (1) FIELD OF THE INVENTION

The disclosure relates to translating devices and more particularly pertains to a new translating device for real time and delayed playback of translated speech.

### (2) Description of Related Art Including Information Disclosed Under 37 CFR 1.97 and 1.98

The prior art relates to translating devices, which may comprise devices for translating speech, earphone jacks, visual displays, and wireless earpieces.

### (h) BRIEF SUMMARY OF THE INVENTION

An embodiment of the disclosure meets the needs presented above by generally comprising a microprocessor positioned in an interior space defined by a housing. The microprocessor is operationally engaged to a data storage module, which is engaged to the housing and positioned in the interior space. The microprocessor also is operationally engaged to a microphone and a speaker, which are engaged to the housing. Translation programming code positioned on the microprocessor enables the microprocessor to translate an incoming audio signal received from the microphone from a first language to a second language. The translation programming code also enables the microprocessor to selectively send a translated audio signal to the data storage module and the speaker.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a translating, recording, and playback device according to an embodiment of the disclosure.

FIG. 2 is a side view of an embodiment of the disclosure.

FIG. 3 is a bottom view of an embodiment of the disclosure.

FIG. 4 is a front view of an embodiment of the disclosure.

FIG. 5 is a block diagram of an embodiment of the disclosure.

### (j) DETAILED DESCRIPTION OF THE INVENTION

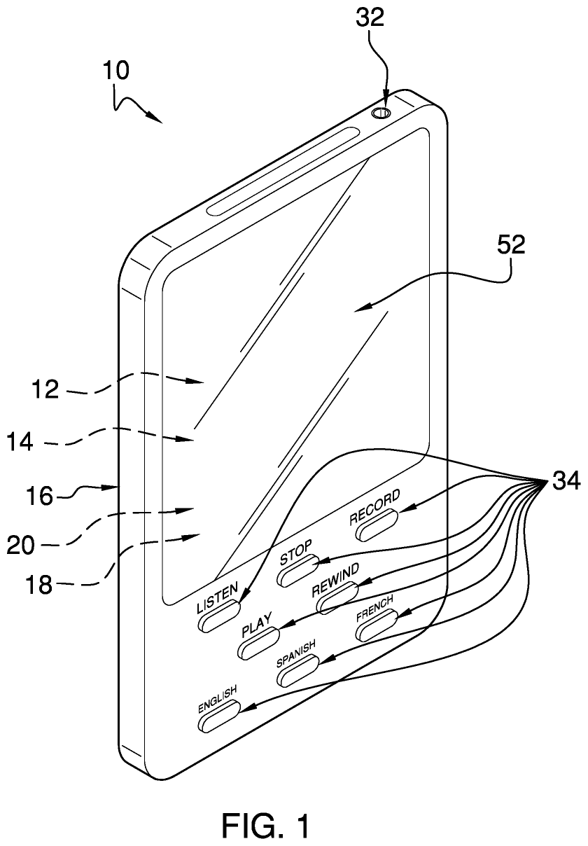

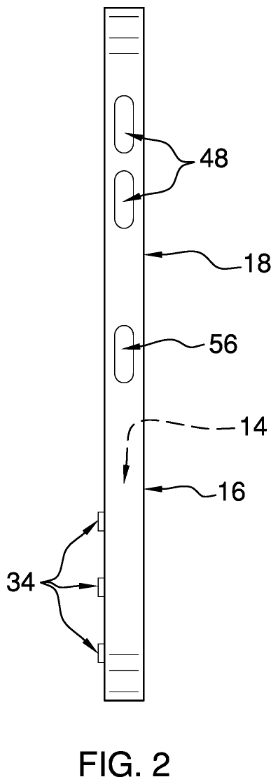

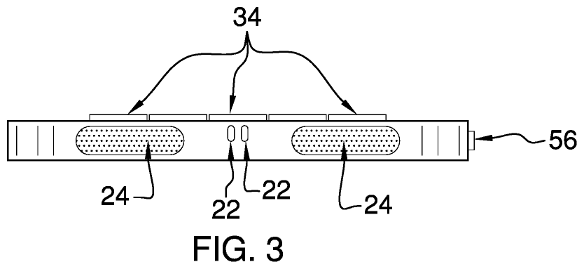

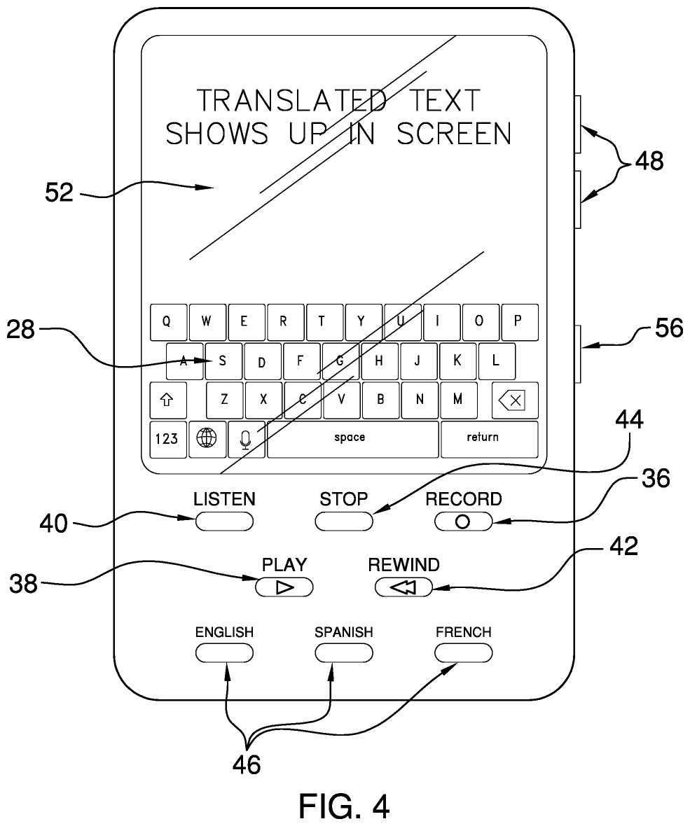

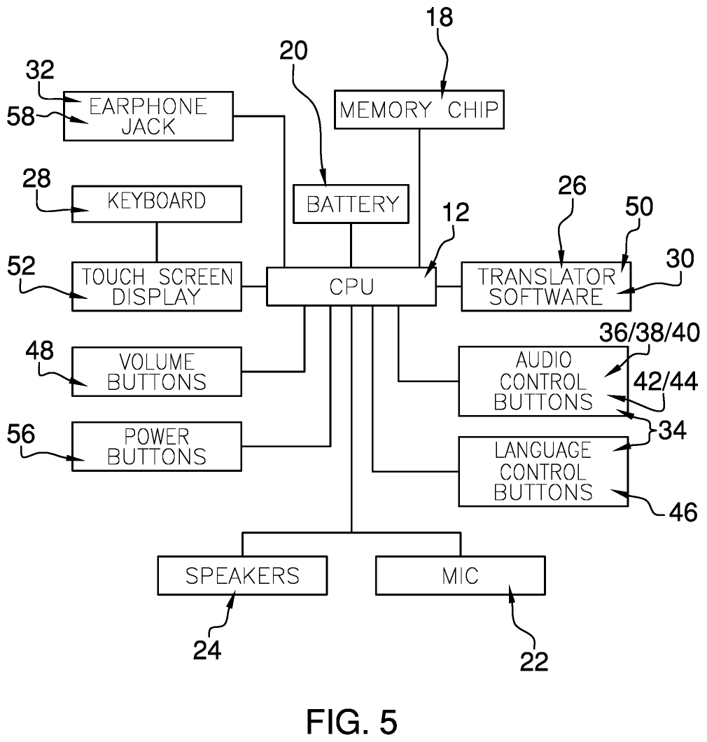

With reference now to the drawings, and in particular to FIGS. 1 through 5 thereof, a new translating device embodying the principles and concepts of an embodiment of the disclosure and generally designated by the reference numeral 10 will be described.

As best illustrated in FIGS. 1 through 5, the translating, recording, and playback device 10 generally comprises a microprocessor 12 positioned in an interior space 14 defined by a housing 16. The microprocessor 12 is operationally engaged to a data storage module 18 and a battery 20, which are engaged to the housing 16 and positioned in the interior space 14. The microprocessor 12 also is operationally engaged to a microphone 22 and a speaker 24, which are engaged to the housing 16.

Translation programming code 26 positioned on the microprocessor 12 enables the microprocessor 12 to translate an incoming audio signal received from the microphone 22 from a first language to a second language. The translation programming code 26 also enables the microprocessor 12 to selectively send a translated audio signal to the data storage module 18 and the speaker 24.

The present invention anticipates the first language being the same as the second language. In this way, speech that is difficult for a user to understand, such as speech that is heavily accented or softly spoken, can be converted by the microprocessor 12 into a translated audio signal that is easily understood by the user upon broadcast by the speaker 24.

A keyboard 28 is engaged to the housing 16 and is operationally engaged to the microprocessor 12. Text to speech programming code 30 positioned on the microprocessor 12 enables the microprocessor 12 to convert text entered via the keyboard 28 into an audible signal and to command the speaker 24 to broadcast the audible signal. The translation programming code 26 also enables the microprocessor 12 to translate text entered via the keyboard 28 prior to sending the audible signal the speaker 24 to be broadcast.

The keyboard 28 may be hingedly engaged to the housing 16 so that the keyboard 28 is selectively positionable in a deployed configuration and a stowed configuration. In the deployed configuration the keyboard 28 extends transversely from the housing 16. In the stowed configuration, the keyboard 28 is in substantial abutment to, or recessed into, the housing 16.

A connector 32, such as an earphone jack 58, is engaged to the housing 16 and is operationally engaged to the microprocessor 12. The connector 32 is configured to selectively engage a headphone cord (not shown). The microprocessor 12 is positioned to selectively send the translated audio signal to headphones that are engaged to the headphone cord.

A control panel 34 is engaged to the housing 16 and is operationally engaged to the microprocessor 12. The control panel 34 is configured for entry of commands into the microprocessor 12 to select a second language into which the incoming audio signal is to be translated, to initiate recording of the translated audio signal, and to initiate, to stop, and to select a timepoint for playback of the translated audio signal.

The control panel 34 comprises a record button 36, a play button 38, a listen button 40, a rewind button 42, a stop button 44, and a plurality of language selector buttons 46. The listen button 40 is configured to be depressed to activate the microphone 22. The record button 36 is configured to be depressed to initiate translation of the incoming audio signal and to record the translated audio signal. The play button 38 is configured to be depressed to initiate playback of the translated audio signal. The rewind button 42 is configured to be depressed to select an earlier timepoint for playback of the translated audio signal. The stop button 44 is configured to be depressed to stop playback of the translated audio signal. Each language selector button 46 is configured to be depressed to select a respective second language for translation of the incoming audio signal.

A volume controller 48 is engaged to the housing 16 and is operationally engaged to the microprocessor 12. The volume controller 48 is configured to be manipulated to adjust a volume of the playback of the translated audio signal.

Speech to text programming code 50 positioned on the microprocessor 12 enables the microprocessor 12 to convert speech received via the microphone 22 in a first language into text in a second language. A display 52 is engaged to the housing 16 and is operationally engaged to the microprocessor 12. The display 52 is configured to present the text in the second language. The display 52 may be touch enabled so that the display 52 is configured for entry of commands into the microprocessor 12. The present invention also anticipates the keyboard 28 being emulated on the display 52.

A switch 54 is engaged to the housing 16 and is operationally engaged to the battery 20 and the microprocessor 12. The switch 54 is configured to be switched to operationally engage the battery 20 to the microprocessor 12 to provide power thereto. The switch 54 comprises a power button 56, which is configured to be depressed a first time to power the microprocessor 12 and to be depressed a second time to depower the microprocessor 12.

In use, the device 10 is utilized to translate an incoming audio signal received from the microphone 22 from a first language to a second language, allowing the user to hear translated speech in real time or at a later time by depressing the play button 38.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

1. A translating, recording, and playback device comprising:
a housing defining an interior space;
a microprocessor engaged to the housing and positioned in the interior space;
a data storage module engaged to the housing and positioned in the interior space, the data storage module being operationally engaged to the microprocessor;
a microphone engaged to the housing and operationally engaged to the microprocessor;
a speaker engaged to the housing and operationally engaged to the microprocessor;
a display engaged to the housing and operationally engaged to the microprocessor, wherein the display is touch enabled;
a keyboard engaged to the housing and operationally engaged to the microprocessor, the keyboard being positioned on the display wherein the display is configured for entry of commands into the microprocessor;
text to speech programming code positioned on the microprocessor enabling the microprocessor for converting text entered via the keyboard into an audible signal and for signaling the speaker for broadcasting the audible signal; and
translation programming code positioned on the microprocessor enabling the microprocessor for translating an incoming audio signal received from the microphone from a first language to a second language and for selectively sending a translated audio signal to the data storage module and the speaker, wherein the display is configured for presenting the text in the second language.

2. The translating, recording, and playback device of claim 1, further including a battery engaged to the housing and positioned in the interior space, the microprocessor being operationally engaged to the battery.

3. (canceled)

4. (canceled)

5. The translating, recording, and playback device of claim 1, further including a connector engaged to the housing and operationally engaged to the microprocessor, the connector being configured for selectively engaging a headphone cord, wherein the microprocessor is positioned for selectively sending the translated audio signal to headphones engaged to the headphone cord.

6. The translating, recording, and playback device of claim 1, further including a control panel engaged to the housing and operationally engaged to the microprocessor, wherein the control panel is configured for entry of commands into the microprocessor for activating the microphone, for selecting a second language for translation thereinto of the incoming audio signal, for initiating recording of the translated audio signal, for initiating, stopping and timepoint selection for playback of the translated audio signal.

7. The translating, recording, and playback device of claim 6, wherein the control panel comprises a listen button, a record button, a play button, a rewind button, a stop button, and a plurality of language selector buttons, wherein listen button is configured for being depressed for activating the microphone, the record button is configured for being depressed for initiating translation of the incoming audio signal and recording of the translated audio signal, wherein the play button is configured for being depressed for initiating playback of the translated audio signal, wherein the rewind button is configured for being depressed for selecting an earlier timepoint for playback of the translated audio signal, wherein the stop button is configured for being depressed for stopping playback of the translated audio signal, wherein each language selector button is configured for being depressed for selecting a respective second language for translation thereinto of the incoming audio signal.

8. The translating, recording, and playback device of claim 1, further including speech to text programming code positioned on the microprocessor enabling the microprocessor for converting speech received via the microphone in a first language into text in a second language.

9. (canceled)

10. The translating, recording, and playback device of claim 1, further including a volume controller engaged to the housing and being operationally engaged to the microprocessor, wherein the volume controller is configured for being manipulated for adjusting a volume of the playback of the translated audio signal.

11. The translating, recording, and playback device of claim 2, further including a switch engaged to the housing and being operationally engaged to the battery and the microprocessor, wherein the switch is configured for being switched for operationally engaging the battery to the microprocessor for providing power thereto.

12. The translating, recording, and playback device of claim 11, wherein the switch comprises a power button, wherein the power button is configured for depressing a first time for powering the microprocessor and for depressing a second time for depowering the microprocessor.

13. A translating, recording, and playback device comprising:
a housing defining an interior space;
a battery engaged to the housing and positioned in the interior space;
a microprocessor engaged to the housing and positioned in the interior space, the microprocessor being operationally engaged to the battery;
a data storage module engaged to the housing and positioned in the interior space, the data storage module being operationally engaged to the microprocessor;
a microphone engaged to the housing and operationally engaged to the microprocessor;
a speaker engaged to the housing and operationally engaged to the microprocessor;
translation programming code positioned on the microprocessor enabling the microprocessor for translating an incoming audio signal received from the microphone from a first language to a second language and for selectively sending a translated audio signal to the data storage module and the speaker;
a keyboard engaged to the housing and operationally engaged to the microprocessor;
text to speech programming code positioned on the microprocessor enabling the microprocessor for converting text entered via the keyboard into an audible signal and for signaling the speaker for broadcasting the audible signal;
a connector engaged to the housing and operationally engaged to the microprocessor, the connector being configured for selectively engaging a headphone cord, wherein the microprocessor is positioned for selectively sending the translated audio signal to headphones engaged to the headphone cord;
a control panel engaged to the housing and operationally engaged to the microprocessor, wherein the control panel is configured for entry of commands into the microprocessor for selecting a second language for translation thereinto of the incoming audio signal, for initiating recording of the translated audio signal, for initiating, stopping and timepoint selection for playback of the translated audio signal, the control panel comprising a listen button, a record button, a play button, a rewind button, a stop button, and a plurality of language selector buttons, wherein the listen button is configured for being depressed for activating the microphone, the record button is configured for being depressed for initiating translation of the incoming audio signal and recording of the translated audio signal, wherein the play button is configured for being depressed for initiating playback of the translated audio signal, wherein the rewind button is configured for being depressed for selecting an earlier timepoint for playback of the translated audio signal, wherein the stop button is configured for being depressed for stopping playback of the translated audio signal, wherein each language selector button is configured for being depressed for selecting a respective second language for translation thereinto of the incoming audio signal;
a volume controller engaged to the housing and being operationally engaged to the microprocessor, wherein the volume controller is configured for being manipulated for adjusting a volume of the playback of the translated audio signal
speech to text programming code positioned on the microprocessor enabling the microprocessor for converting speech received via the microphone in a first language into text in a second language;
a display engaged to the housing and operationally engaged to the microprocessor, wherein the display is configured for presenting the text in the second language, the display being touch enabled, the keyboard being positioned on the display wherein the display is configured for entry of commands into the microprocessor; and
a switch engaged to the housing and being operationally engaged to the battery and the microprocessor, wherein the switch is configured for being switched for operationally engaging the battery to the microprocessor for providing power thereto, the switch comprising a power button, wherein the power button is configured for depressing a first time for powering the microprocessor and for depressing a second time for depowering the microprocessor.
